(19) United States
(12) Patent Application Publication
(10) Pub. No.: US 2024/0386291 A1
(43) Pub. Date: Nov. 21, 2024

(54) METHOD FOR AUTOMATED SENSORY PROFILING AND FOOD FORMULATION

(71) Applicant: PIPA LLC, Davis, CA (US)

(72) Inventors: Ilias Tagkopoulos, Davis, CA (US); Tarek Zohdi, Walnut Creek, CA (US); Dimitris Sfondilis, Preveza (GR); Chris Stamelos, Strassen (LU)

(21) Appl. No.: 18/668,010

(22) Filed: May 17, 2024

Related U.S. Application Data
(60) Provisional application No. 63/467,273, filed on May 17, 2023.

(51) Int. Cl. G06N 5/02

(52) U.S. Cl. CPC G06N 5/02

(57) ABSTRACT

A method includes: receiving a baseline food formula defining a baseline set of ingredients for a product; receiving a query for a target ingredient; accessing a baseline sensory profile of the baseline food formula; identifying the target ingredient analogous to a first ingredient, in the baseline set of ingredients, in a database; identifying a first process linking the target ingredient and the first ingredient in the database; exchanging the first ingredient with the target ingredient to generate a first food formula for the product; revising the first food formula with the first process; predicting a first sensory profile of the first food formula for the product based on sensory attributes associated with the target ingredient and the baseline set of ingredients; and, in response to the first sensory profile approximating the baseline sensory profile, serving the first food formula for the product to a user.

### CROSS-REFERENCE TO RELATED APPLICATIONS

This application claims the benefit of U.S. Provisional Application No. 63/467,273 filed on 17 May 2023, which is incorporated in its entirety by this reference.

This application is related to U.S. patent application Ser. No. 17/987,535, filed on 15 Nov. 2022, and U.S. patent application Ser. No. 17/987,567, filed on 15 Nov. 2022, each of which is incorporated in its entirety by this reference.

### TECHNICAL FIELD

This invention relates generally to the field of bioinformatics and more specifically to a new and useful method for automated sensory profiling and food formulation in the field of bioinformatics.

### BRIEF DESCRIPTION OF THE FIGURES

FIGS. 1A and 1B are flowchart representations of a method;

FIG. 2 is a flowchart representation of one variation of the method;

FIG. 3 is a flowchart representation of one variation of the method;

FIGS. 4A and 4B are flowchart representations of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

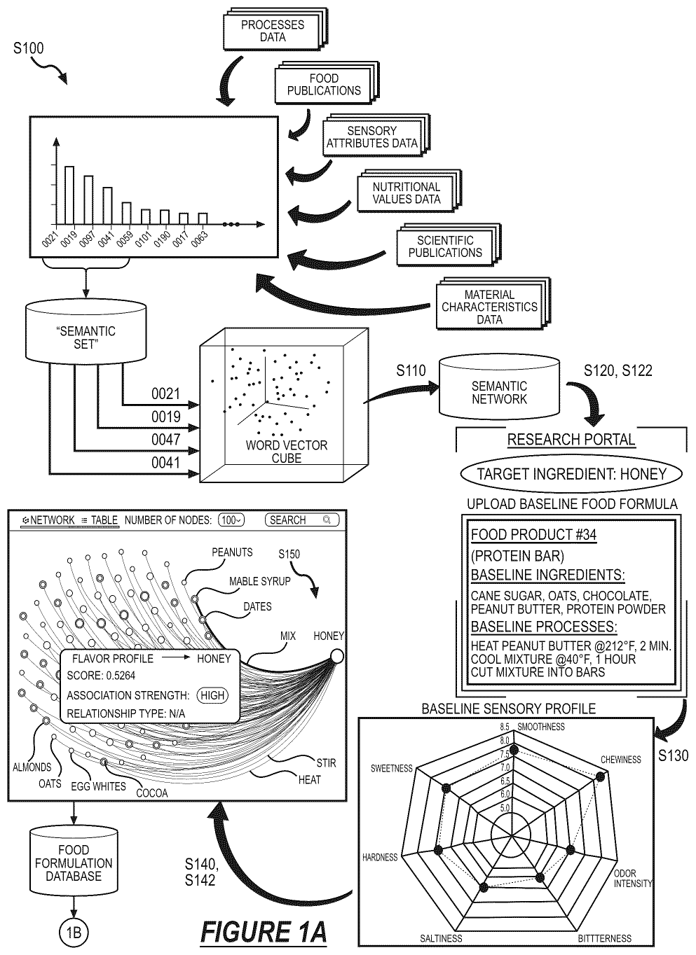

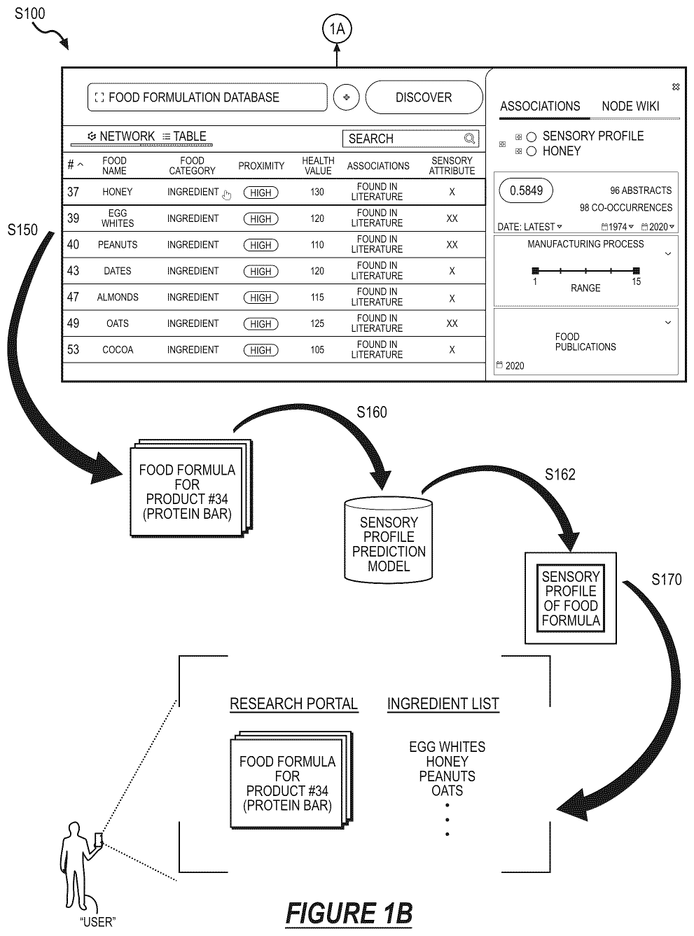

As shown in FIGS. 1A and 1B, a method S100 for automated food formulation includes: accessing a semantic network, which includes a first set of nodes representing food concepts and labeled with sensory attributes and connections between nodes representing processes linking discrete food concepts represented in the first set of nodes in Block S110; receiving a baseline food formula specifying a baseline set of ingredients and a baseline set of processes for a product at a research portal in Block S120; receiving a query for a target ingredient at the research portal in Block S122; and, based on the semantic network, deriving a baseline sensory profile of the baseline food formula for the product in Block S130.

The method S100 further includes generating a set of food formulas predicted to yield the baseline sensory profile by: identifying a second set of nodes, in the semantic network, representing a secondary set of target ingredients nearest the target ingredient in Block S140; identifying a first set of connections, in the semantic network, representing a first set of processes linking the target ingredient and the secondary set of target ingredients in the semantic network in Block S142; aggregating the target ingredient, the secondary set of target ingredients, and the first set of processes into a first food formula, in the set of food formulas in Block S150; accessing a sensory profile prediction model representing relationships between sensory attributes of the baseline set of ingredients and the baseline set of processes for the product in Block S160; and, based on the sensory profile prediction model, the first set of processes, and sensory attributes of the target ingredient and the secondary set of target ingredients, predicting a first sensory profile of the first food formula, in the set of food formulas, for the product in Block S162.

The method S100 further includes, in response to the first sensory profile approximating the baseline sensory profile, returning the first food formula, in the set of food formulas, for the product to the research portal in Block S170.

### 1.1 Variation: Food Formulation Database

One variation of the method S100 includes: accessing a food formulation database, which includes a first set of food concepts labeled with sensory attributes and a first set of processes linking discrete food concepts in the first set of food concepts in Block S110; receiving a baseline food formula defining a baseline set of ingredients for a product at a research portal in Block S120; receiving a query specifying a target ingredient for the product at a research portal in Block S122; accessing a baseline sensory profile of the baseline food formula for the product in Block S130; identifying the target ingredient analogous to a first ingredient, in the baseline set of ingredients, in the food formulation database in Block S144; identifying a first process, in the first set of processes, linking the target ingredient and the first ingredient in the food formulation database in Block S146; exchanging the first ingredient, in the baseline set of ingredients, with the target ingredient within the baseline food formula to generate a first food formula, in a set of food formulas, for the product in Block S152; and revising the first food formula, in the set of food formulas, with the first process in Block S154.

This variation of the method S100 further includes: accessing a sensory profile prediction model representing relationships between sensory attributes of the baseline set of ingredients and the baseline set of processes for the product in Block S160; based on the sensory profile prediction model, sensory attributes associated with the target ingredient, and sensory attributes associated with the baseline set of ingredients, calculating a first sensory profile of the first food formula, in the set of food formulas, for the product in Block S162; and, in response to the first sensory profile approximating the baseline sensory profile, returning the first food formula, in the set of food formulas, for the product to the research portal in Block S170.

### 1.2 Variation: Ingredient Exchange

One variation of the method S100 includes: receiving a baseline food formula defining a baseline set of ingredients for a product in Block S120; receiving a query specifying a target ingredient for the product in Block S122; accessing a baseline sensory profile of the baseline food formula for the product in Block S130; identifying the target ingredient analogous to a first ingredient, in the baseline set of ingredients, stored in a food formulation database in Block S144; identifying a first process, in a first set of processes, linking the target ingredient and the first ingredient in the food formulation database in Block S146; exchanging the first ingredient, in the baseline set of ingredients, with the target ingredient within the baseline food formula to generate a first food formula, in a set of food formulas, for the product in Block S152; and revising the first food formula, in the set of food formulas, with the first process in Block S154.

This variation of the method S100 further includes: predicting a first sensory profile of the first food formula, in the set of food formulas, for the product based on sensory attributes, stored in the food formulation database, associated with the target ingredient and based on sensory attributes, stored in the food formulation database, associated with the baseline set of ingredients excluding the first ingredient in Block S162; and, in response to the first sensory profile approximating the baseline sensory profile, serving the first food formula, in the set of food formulas, for the product to a user in Block S170.

### 2. Applications

Generally, the method S100 can be executed by a computer system (e.g., a computer network, a remote computer system): to detect food concepts (e.g., ingredients, products, chemical compounds, food molecules, bioactive compounds, macronutrients) from a corpus of resources; to label these food concepts with sensory attributes (e.g., taste qualities, texture characteristics, aroma characteristics, nutritional values) and material characteristics (e.g., mechanical properties, appearance factors, rheological properties, thermal properties, material cost); to derive connections between food concepts based on proximity to food concepts in the corpus of resources; to derive domains of these language food concepts based on domain descriptors in the corpus of resources; and to represent these language food concepts labeled with sensory attributes and material characteristics, the connections, and the domains in a semantic network (e.g., a knowledge graph, an ontology) or food formulation database.

The computer system can further execute Blocks of the method S100 to: receive a baseline food formula specifying a set of manufacturing processes and a set of baseline ingredients associated with a product of interest to a user via a user portal (or “research portal”); receive queries representing a target search term (e.g., an ingredient, a sensory profile, a nutritional profile, a material characteristic) from the research portal; scan the semantic network or food formulation database for a set of nodes representing food concepts that correspond to these search terms and for connections (e.g., cooking processes, manufacturing processes) that connect the set of nodes; aggregate ingredients, quantities of ingredients, and processes into a food formula for the product; predict a sensory profile for the food formula according to a sensory profile prediction model; and return the food formula to the research portal responsive to the sensory profile approximating (e.g., analogous to, corresponding to, matching) the baseline sensory profile.

Additionally, responsive to detecting a difference (e.g., a mismatch, a deviation) between the sensory profile and the baseline sensory profile, the computer system can: modify the quantities of the target ingredients; aggregate these target ingredients, modified quantities of these target ingredients, and the processes into a new food formula for the product; and return the food formula to the research portal responsive to the sensory profile approximating the baseline sensory profile.

Alternatively, responsive to detecting a difference, such as a sweetness difference, between the sensory profile and the baseline sensory profile, the computer system can: identify a set of additive ingredients labeled with a sweetness sensory attribute in the semantic network to reduce the sweetness difference; identify any new processes linking the set of additive ingredients to the set of target ingredients; aggregate these target ingredients, additive ingredients, and the new processes into a new food formula for the product; and return the food formula to the research portal responsive to the sensory profile approximating the baseline sensory profile. The user may then selectively target or prioritize research and development of certain ingredients specified in the food formula rather than manually experimenting with recipes and ingredient combinations to reduce the sweetness difference.

For example, a user may hypothesize that replacing an ingredient (e.g., cane sugar) with a natural sweetener (e.g., maple syrup) may be effective in increasing the nutritional profile of a protein bar (e.g., a nutritional composition of ingredients in a protein bar) and thus increase the health benefits of the protein bar, such as a particular enzyme production, a particular hormone production, promote muscle growth, or promote muscle recovery. However, the natural sweetener (e.g., maple syrup) may cause the protein bar to exhibit a new sensory profile during consumption. Thus, the user may: define the baseline food formula specifying a baseline set of ingredients and a baseline set of processes available to the user for the protein bar within the research portal; and enter a query for a target ingredient (e.g., maple syrup) in the research portal to trigger the computer system to identify a set of target ingredients for combination with the target ingredient. The computer system can then execute Blocks of the method S100: to generate a set of food formulas, defining the set of target ingredients and a corresponding set of processes, predicted to increase the nutritional profile of the protein bar and maintain the baseline sensory profile; and to render this set of food formulas within the research portal for the user.

Thus, the computer system can: return immediate and meaningful food formulas—defining new ingredients, quantities (e.g., concentrations, dry masses) of these ingredients, and associated processes informed by the semantic network—for a product that are predicted to yield a baseline sensory profile; and reduce noise, resulting from different ingredient combinations for the product that yield a change in the sensory profile, in recipe experimentation results.

Therefore, the computer system can execute Blocks of the method S100 to serve these data, food formulas, instructions, insights, suggestions, and/or recommendations to users associated with a particular product, region of products, and/or product type—such as a consumer food manager, a farmer, a food supplier, a food scientist, a retailer, etc.—thus enabling these users to streamline research and development of ingredients, sensory profiles, nutritional profiles, and manufacturing processes for products consumable by humans (and other animals). For example, the computer system can execute Blocks of the method S100 to identify and propose: new food formulas for a product; target ingredients to address a target nutritional value range for the product; substitute ingredients to replace a baseline ingredient and address a target sensory profile or target material characteristic for the product; and/or processes (e.g., manufacturing processes, cooking processes) that address a process threshold for the product.

### 3. Terms

Generally, the semantic network (e.g., knowledge graph, ontology) includes: a population of nodes representing food concepts labeled with sensory attributes and material characteristics; and connections representing processes (e.g., extrusion, mixing, heating, cooling, processing, proofing) between food concepts represented in the population of nodes.

More specifically, a food concept (e.g., an ingredient, a chemical compound, food molecules, bioactives, macronutrients, a product) can be represented within a node in the semantic network. Sensory attributes can include: taste qualities (e.g., bitterness, sweetness, saltiness, sourness, umami taste); texture characteristics (e.g., hard, soft, creamy, crunchy, chewy, crispy, sticky, crumbly, rubbery, thick, grainy); aroma attributes (e.g., fruity, floral, citrus, spicy, roasted, herbal, nutty, woody, cheesy, chemical); and/or nutritional values (e.g., calories, fat, carbohydrates, proteins, sugars, sodium, fiber).

Material characteristics can include: mechanical properties (e.g., Young's modulus, density, viscosity, height, hardness, brittleness, elasticity, bulk modulus, surface tension); appearance factors (e.g., dimensions, shape, gloss, transparency, color, consistency, uniformity); rheological properties (e.g., torque, viscosity, deflection angle, yield stress); thermal properties (e.g., thermal conductivity, thermal diffusivity, heat capacity); and/or material cost (e.g., price of food concept per quantity, price of manufacturing the product, price of packaging the product, price of shelf-life of the product).

Furthermore, a user can enter queries within a user portal (or “research portal”) to streamline research and development of ingredients, sensory profiles, nutritional profiles, and processes for products consumable by humans (and other animals) informed by the semantic network.

### 4. Resources

Generally, the computer system can access a corpus of resources (e.g., scientific publications, food publications) and compile a population of semantic food concepts represented in the corpus of resources into a vector space model based on proximity of semantic food concepts within individual resources, in the corpus of resources and frequency of semantic food concepts across the corpus of resources.

In particular, the computer system can retrieve scientific papers and journal publications, food publications, chemical compound data, food molecule data, ingredient data, product recipe data, gustatory sensation data, taste perception data, sensory perception data, aroma profile data, texture analysis data, food appearance data, mechanical properties data, rheological properties data; thermal properties data, material cost data, and/or nutritional profile data, etc. from one or more resource databases.

### 5. Word Vector Cube

In one implementation, the computer system can compile a population of semantic food concepts represented in the corpus of resources into a vector space model based on proximity of semantic food concepts within individual food publications and frequency of semantic food concepts across the corpus of resources. Generally, the computer system can construct a vector space model (e.g., a “word vector cube”) that represents (or “embeds”) word representations from the corpus of resources in a continuous vector space where semantically-related word representations are mapped to nearby points in the vector space—that is, semantically-related word representations are “embedded” proximal each other in the vector space.

More specifically, the computer system can generate a multi-dimensional word vector cube that contains a large population of food concepts (e.g., ingredients, chemical compounds, food molecules, macronutrients, products) mapped according to semantic proximity derived from the corpus of resources. Each object in the word vector cube: can include a word or phrase representing a food concept (e.g., a product name, an ingredient name, a food type, a common chemical compound name); and can be located at a “distance” (e.g., a multi-dimensional spatial distance, a weight, a proximity value) to another object in the word vector cube corresponding to a frequency that words or phrases represented by these two objects occur together in individual resources in the corpus.

### 5.1 Vector Space Modeling

In one implementation, the computer system: accesses documents from a corpus of resources; detects and discards stop words (e.g., ‘a’, ‘the’, ‘ourselves’, ‘hers’, ‘between’, ‘yourself’, ‘but’, ‘again’, ‘there’, ‘about’, ‘once’, ‘out,’ ‘we,’ ‘its’) from each document; and initiates generation of the word vector cube based on the remaining words in these documents. The computer system can then implement statistical methods to identify a unique combination of words occurring in each document in this corpus of resources, such as a unique combination of five words or a quantity of words proportional to a length of a document. For example, to identify a unique combination of words in one document in the corpus of resources, the computer system can: detect and remove all stop words from the document; convert all plurals of words in the document to their singular forms; implement statistical methods to identify a target quantity of words occurring with greatest frequency in the document; and store these words as a combination of words tagged with a topic label extracted from this document. The computer system can repeat this process for each other document in the corpus of resources to generate a population of topic words tagged with topics represented across the corpus of resources.

The computer system can then implement vector space modeling techniques to aggregate this population of objects into a multi-dimensional word vector cube with many nodes—each containing one object in the population—related spatially based on proximity of corresponding topic words occurring throughout the corpus of resources.

### 5.2 Food Concepts

Generally, the corpus of resources may describe a range of food concepts (and directly or indirectly inform relationships between these food concepts) such as: volatile organic compounds; products (e.g., bread, protein bars, cereal, pasta, cookies, burritos); ingredients (e.g., flour, milk, cane sugar, oats, yeast, chocolate chips, tomatoes, carrots, rice); inorganic chemicals, and/or organic chemicals; waste products; food groups; sample food recipes (e.g., a food name, list of ingredients, duration, procedure, nutrition information); etc.

Accordingly, the computer system can implement the foregoing methods and techniques to extract food concepts within these domains from the corpus of resources, to characterize their proximities in these documents and across the corpus of resources, and to represent these proximities within a word vector cube or other vector space model.

### 6. Semantic Network

The computer system can then generate a semantic network (e.g., knowledge graph, ontology): including a set of nodes representing food concepts and labeled with sensory attributes and material properties; and including connections between nodes representing processes (e.g., manufacturing processes, cooking processes, baking processes) linking discrete food concepts.

Generally, the computer system can generate a semantic network that represents proximities (or “associations”) of food concepts in the word vector cube, sensory attributes of food concepts, material characteristics of food concepts, and processes linking these food concepts informed by the corpus of resources.

### 6.1 Food Concept Domain

In one implementation, the computer system also predicts domains (e.g., textual descriptors, textual names, values on a scale from one to ten representing textual names, or symbols) of food concepts represented in the word vector cube and/or filters food concepts represented in the word vector cube to include a particular set of relevant (or “target”) domains, such as: ingredients; volatile organic compounds; macronutrients; chemical compounds; food molecules; products; etc.

For example, the computer system can apply standard naming conventions for chemical formulae to identify particular words or phrases in the word vector cube as volatile organic compounds or aroma molecules in the semantic network. The computer system can further apply standard naming conventions for each domain to identify particular words or phrases in the word vector cube and label food concepts in the semantic network with their domains accordingly.

Additionally or alternatively, the computer system can: detect domain descriptors in the word vector cube; and identify or predict the domain of a particular food concept (e.g., a word or phrase) in the word vector cube based on a domain descriptor nearest this food concept in the word vector cube. For example, the computer system can identify a food concept in the word vector cube as “ingredient” between the food concept and other objects—identified as [ingredient, fruit, grain, protein, spices, vegetable, natural flavor, and/or nutrient] domain descriptors in the word vector cube—based on proximity of the food concept and the other objects that is, inversely proportional to an n-dimensional distance between the food concept and each other object in the word vector cube.

### 6.2 Sensory Attributes+Material Characteristics

In one implementation, once the computer system extracts food concepts within domains from the corpus of resources, the computer system can extract sensory attributes, such as taste qualities, texture characteristics, aroma attributes, and/or nutritional values, of each food concept based on proximity (e.g., distance between the food concept and a sensory attribute, number of letters or words between the food concept and the sensory attribute) within individual resources in the corpus of resources. For example, the computer system can: identify a sweetness taste quality within a threshold distance, such as ten words, of sugar (e.g., glucose, fructose, galactose, sucrose) within a resource; extract a taste quality score (e.g., a percentage between 0 percent and 99 percent, a value on a scale from one to 10, categorized as “weak,” “moderate,” “strong,” or “very strong”) from the resource; and label the sugar concept within the word vector cube with the taste quality score.

Furthermore, the computer system can implement these methods and techniques to extract material characteristics, such as mechanical properties, thermal properties, rheological properties; appearance factors, and/or material cost, based on proximity within individual resources in the corpus of resources.

### 6.3 Processes

In one implementation, the computer system can generate a connection between two food concepts based on proximity of a particular process to the two food concepts within the word vector cube. For example, for two ingredients (e.g., flour and yeast) represented within the word vector cube, the computer system can generate a connection representing a particular process inversely proportional to an n-dimensional distance between these two ingredients in the word vector cube.

In another implementation, the computer system can: generate a connection between two food concepts representing a process—such as a cooking process, a baking process, a manufacturing process, or a transformation—based on frequency of occurrence of the process between paired instances of these two food concepts across the corpus of resources. For example, for two ingredients (e.g., flour and yeast) represented within the word vector cube, the computer system can: identify a set of resources in the corpus of resources that includes at least one paired instance of these two ingredients within a threshold distance—such as a number of letters or words—of a particular process; detect a number of times (or “frequency of occurrence”) that these two ingredients appear within the threshold distance of the particular process; and, in response to the frequency of occurrence exceeding a threshold frequency, generate a connection between the two ingredients representing the particular process.

### 6.4 Semantic Network Construction

The computer system can then: populate a semantic network with a corpus of nodes, each representing a unique food concept—in the set of target domains—described in at least one resource in the corpus of resources; label each node with its corresponding sensory attributes and material characteristics; and define connections, representing processes, between nodes in the semantic network.

The computer system can therefore: fuse the corpus of resources into a network of language embeds (e.g., a “word vector cube”); derive connections, representing processes, between food concepts represented in the word vector cube; detect or predict domains of food concepts in the word vector cube; derive sensory attribute and material characteristic values of food concepts represented in the word vector cube; represent these food concepts as nodes in the semantic network; label each node with the domain of the food concept represented by the node; and connect (or “link”) pairs of nodes with connections representing processes for pairs of food concepts represented by these nodes.

### 7. User Query: Target Ingredient+Baseline Food Formula

Blocks S120 and S122 of the method S100 recite: receiving a baseline food formula specifying a baseline set of ingredients and a baseline set of processes for a product at a research portal; and receiving a query for a target ingredient at the research portal. Generally in Blocks S120 and S122, the computer system can interface with the research portal to retrieve a baseline food formula for a product and a query specifying a target ingredient, a target sensory profile, a target nutritional profile, a target quantity of processes, and/or a target material characteristic for the product.

In one implementation, a user may enter a baseline food formula specifying a baseline set of ingredients and a baseline set of processes for a product at the research portal. The user may then enter a query for a target ingredient to trigger the computer system: to derive a baseline sensory profile of the baseline food formula; to detect a target node representing the target ingredient; and to identify a secondary set of target ingredients near the target ingredient in the semantic network—such as a set of nodes in the semantic network labeled with an ingredient domain and that fall near a target node representing the target ingredient within the semantic network—predicted to yield a sensory profile analogous to the baseline sensory profile when combined (e.g., mixed, processed) according to a food formula.

In one variation, the computer system can derive the baseline sensory profile of the baseline food formula from the semantic network. The computer system can: identify a set of nodes representing the baseline set of target ingredients; extract sensory attributes associated with the baseline set of ingredients from the set of nodes; and derive relationships between these sensory attributes and the baseline set of processes to generate a baseline sensory profile of the baseline food formula, as further described below.

### 7.1 Secondary Target Ingredients

Block S140 of the method S100 recites identifying a second set of nodes, in the semantic network, representing a secondary set of target ingredients nearest the target ingredient. Generally, in Block S140, the computer system can then query the semantic network for a set of nodes representing secondary target ingredients (e.g., chocolate chips, protein powder, peanut butter) proximal the target node representing the target ingredient (e.g., oats) in the semantic network.

In one implementation, once the user enters the baseline food formula and a query for the target ingredient, the computer system can scan the semantic network for an address of a target node within the “ingredient” domain and containing a language concept representing the target ingredient. The computer system can further scan the semantic network for a set of nodes-within the ingredient domain-nearest the target node. For example, the computer system: identifies a target node representing the target ingredient; defines a threshold distance (e.g., a threshold Euclidean distance in n-dimensions of the semantic network) proportional to a target quantity of ingredients, such as five ingredients, nearest the target ingredient; and identifies a set of nodes, representing a secondary set of target ingredients, within the threshold distance of the target node and predicted to yield the baseline sensory profile when combined with the target ingredient.

In another example, the computer system identifies a set of nodes, representing secondary target ingredients, within a threshold distance of the target node, such as a threshold Euclidean distance in n-dimensions of the semantic network between each node in the set of nodes and the target ingredient node, and predicted to yield the baseline sensory profile when combined with the target ingredient.

### 7.2 Process Detection+Food Formulation

Block S142 of the method S100 recites: identifying a first set of connections, in the semantic network, representing a first set of processes linking the target ingredient and the secondary set of target ingredients. Generally, in Block S142, the computer system can: scan the semantic network for connections linking the set of nodes representing the secondary set of target ingredients and the target node representing the target ingredient; and generate a set of food formulas—predicted to yield the baseline sensory profile—for the product.

In one implementation, the computer system can: identify a set of connections representing a set of processes-such as cooking processes or manufacturing processes annotated with target temperatures and durations of these processes-linking the target ingredient and the secondary set of target ingredients in the semantic network; and aggregate the target ingredient, the secondary set of ingredients, and the set of processes into a food formula in a set of food formulas in Block S150.

In one variation, the computer system can further generate a set of quantities (e.g., dry masses, proportions) of the secondary set of target ingredients and update the food formula with these quantities. For example, the computer system can generate a set of dry masses of the secondary set of target ingredients for a protein bar. The secondary set of ingredients annotated with the baseline set of dry masses can include: 420 grams of oats; 200 grams of mini chocolate chips; 30 grams of peanut butter; and 60 grams of vanilla protein powder. The set of processes can include: heat the peanut butter for 2 minutes seconds at 212 degrees fahrenheit in a bowl; mix in the oats, protein power, and mini chocolate chips; spread the mixture onto a pan; refrigerate the mixture for one hour at 40 degrees fahrenheit; and process (e.g., slice, cut) the mixture into ten protein bars. The computer system can then aggregate the target ingredient, the secondary set of target ingredients annotated with a set of quantities, and the set of processes into the food formula for the protein bar.

### 8. Sensory Profile Prediction

Generally, the computer system can generate a food formula, defining ingredients, quantities of ingredients, and processes, for a particular product and implement a sensory profile prediction model to calculate a sensory profile for the food formula. The computer system can implement regression, machine learning, deep learning and/or other techniques to derive correlations between food concepts and sensory attributes informed by the corpus of resources. The computer system can then selectively return the food formula to the research portal for review by a user responsive to the sensory profile approximating (e.g., corresponding to, analogous to, matching) the baseline sensory profile.

### 8.1 Sensory Profile Prediction Model

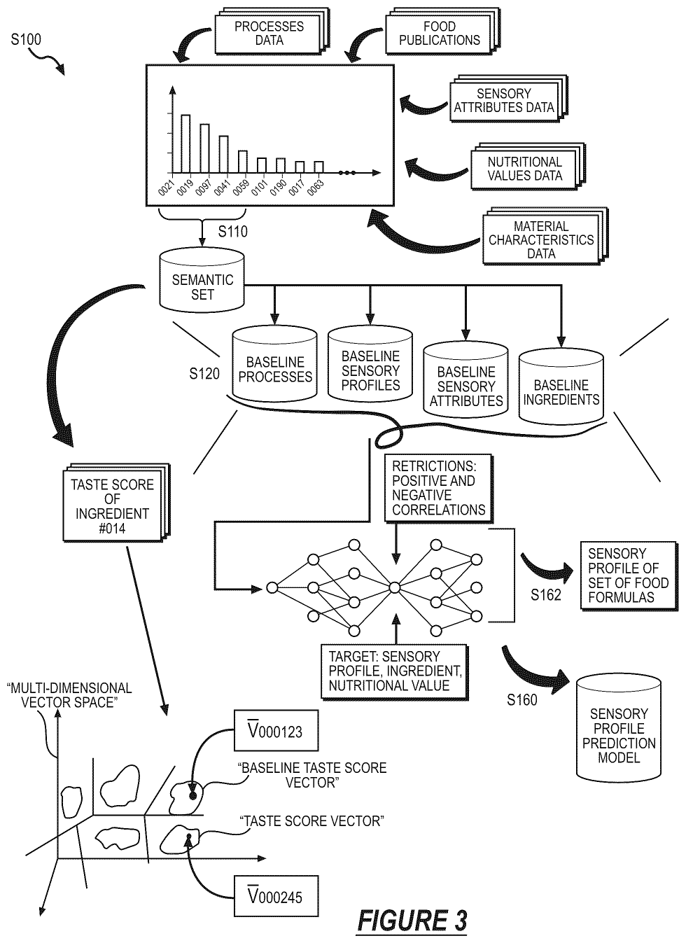

Block S160 of the method S100 recites: accessing a sensory profile prediction model representing relationships between sensory attributes of the baseline set of ingredients and the baseline set of processes for the product. Generally in Block S160 of the method S100, the computer system can derive a sensory profile prediction model configured to predict a sensory profile for a particular food formula, for a particular product, and/or a particular food type, as shown in FIG. 3.

In one implementation, the computer system can: interface with the research portal to retrieve the baseline food formula, specifying a baseline set of ingredients and a baseline set of processes, and a baseline sensory profile for a particular product; extract a set of sensory attributes associated with the baseline set of ingredients in the semantic network; represent the baseline sensory profile, the baseline set of processes, and the set of sensory attributes in a first container associated with the particular product; and, based on the baseline sensory profile, the baseline set of processes, and the set of sensory attributes, derive a sensory profile prediction model representing relationships between sensory attributes of the baseline set of ingredients, the baseline set of processes, and the baseline sensory profile for this particular product.

The computer system can repeat these methods and techniques for a corpus of products to further refine the sensory profile prediction model. In particular, the computer system can: generate a set of containers, such as including the first container associated with the particular product, a second container generated for a second product, a third container generated for a third product, a fourth container generated for a fourth product, etc.; and rectify the sensory profile prediction model according to each container in the corpus of containers generated for the corpus of products. For example, the computer system can: access a corpus of scientific publications; extract a baseline food formula in a set of baseline food formulas, specifying a baseline set of ingredients and a baseline set of processes for the product, from the corpus of scientific publications; extract a baseline sensory profile, representing a set of sensory attributes, for the product from the corpus of scientific publications; represent the baseline food formula and baseline sensory profile in a container, in a set of containers, associated with the food product; and, based on the set of containers, derive the sensory profile prediction model linking baseline sets of ingredients and baseline sets of processes to baseline sensory profiles.

In one variation, the computer system can repeat these methods and techniques to derive a sensory profile prediction model for products of each food type. For example, the computer system can: derive a first sensory profile prediction model configured to predict sensory profiles of food formulas for protein bar products; derive a second sensory profile prediction model configured to predict sensory profiles of food formulas for bread products; derive a third sensory profile prediction model configured to predict sensory profiles of food formulas for cookie products; derive a fourth sensory profile prediction model configured to predict sensory profiles of food formulas for dairy products; etc.

### 8.2 Sensory Profile Calculation+Food Formula Output

Block S162 of the method S100 recites, based on the sensory profile prediction model, the first set of processes, and sensory attributes of the target ingredient and the secondary set of target ingredients, predicting a first sensory profile of the first food formula, in the set of food formulas, for the product.

More specifically in Block S162, the computer system can insert the set of processes and sensory attributes of the target ingredient and the secondary set of target ingredients into the sensory profile prediction model for the particular product to predict the sensory profile of the food formula for the particular product. Responsive to the sensory profile approximating (e.g., analogous to, corresponding to, matching) the baseline sensory profile, the computer system can return the food formula, in the set of food formulas, for the product within the research portal for a user to review.

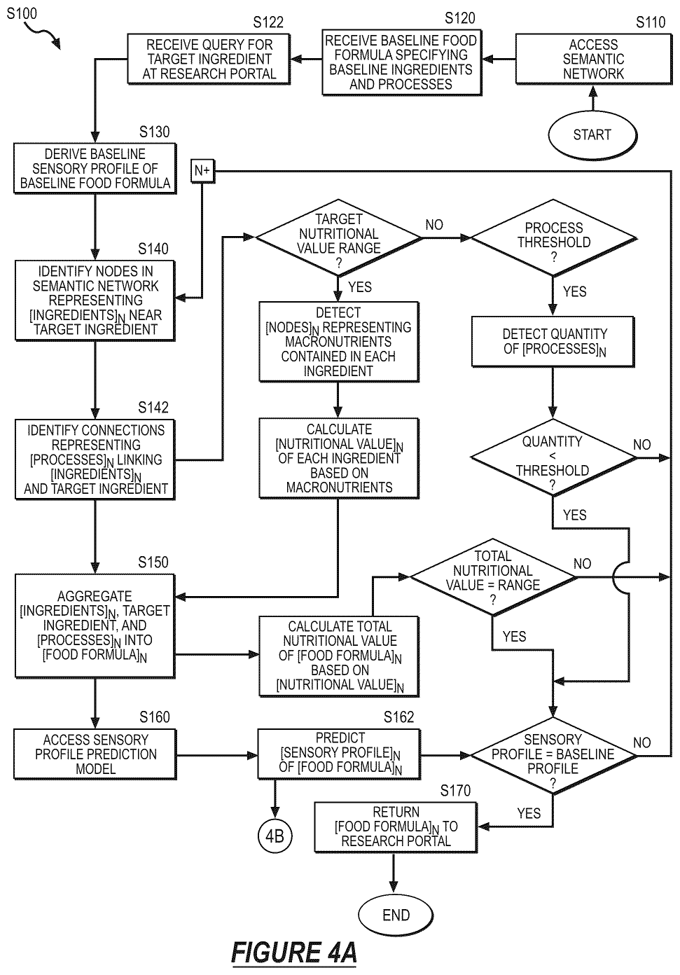

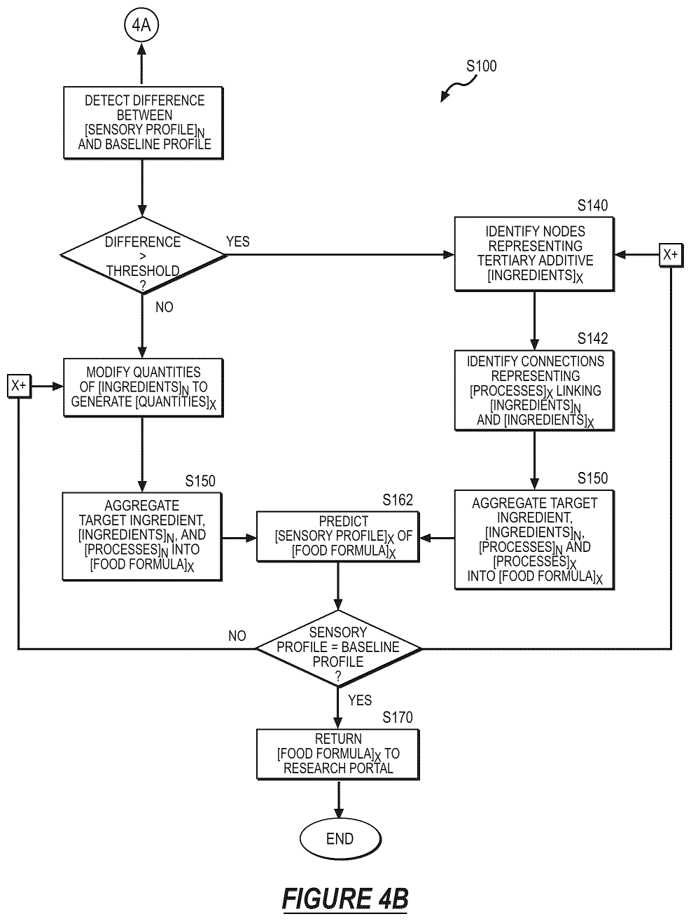

In one variation, responsive to a difference between the sensory profile of the food formula and the baseline sensory profile of the baseline food formula, the computer system can modify the quantities of the secondary set of ingredients to generate a second set of quantities different from the first set of quantities in order to reduce the difference between the sensory profile and the baseline sensory profile. For example, in response to detecting a difference between the sensory profile and the baseline sensory profile, the computer system can: modify the first set of quantities of the secondary set of target ingredients to generate a second set of quantities different from the first set of quantities; compile the target ingredient, the secondary set of target ingredients annotated with the second set of quantities, and the first set of processes into a second food formula, in the set of food formulas; and, based on the sensory profile prediction model, the second set of quantities, the first set of processes, and sensory attributes associated with the target ingredient and the secondary set of ingredients, calculate a second sensory profile of the second food formula, in the set of food formulas, for the product. Then, in response to the second sensory profile approximating the baseline sensory profile, the computer system can render the second food formula, in the set of food formulas, for the product within the research portal, as shown in FIG. 4B.

In another variation, responsive to a difference between the sensory profile and the baseline sensory profile, the computer system can identify a tertiary set of additive ingredients and update the food formula with these additive ingredients to reduce the difference. For example, in response to detecting a difference between the sensory profile and the baseline sensory profile, the computer system can: identify a second set of nodes, in the semantic network, representing a tertiary set of additive ingredients predicted to reduce the difference between the first sensory profile and the baseline sensory profile; identify a second set of connections, in the semantic network, representing a second set of processes linking the secondary set of target ingredients and the tertiary set of additive ingredients; aggregate the target ingredient, the secondary set of target ingredients, the first set of processes, the tertiary set of additive ingredients, and the second set of processes into a second food formula, in the set of food formulas; and, based on the sensory profile prediction model, sensory attributes associated with the target ingredient, the secondary set of ingredients, and the tertiary set of additive ingredients, the first set of processes, and the third set of processes, calculate a second sensory profile of the second food formula in the set of food formulas. Then, in response to the second sensory profile approximating the baseline sensory profile, the computer system can render the second food formula, in the set of food formulas, for the product within the research portal, as shown in FIG. 4B.

Therefore, the computer system can iteratively adjust a quantity of each secondary target ingredient or identify additional additive ingredients in the semantic network to combine with the target ingredient in order to reduce a difference between a sensory profile of a food formula and the baseline sensory profile of the baseline food formula for a particular product.

### 8.3 Taste Perception+Taste Scores

In one variation, the computer system can generate a food formula, defining ingredients, quantities of ingredients, and processes, for a particular product and generate a total taste score of the food formula for a product representing a predicted taste perception during consumption of the product by a human (or other animals). The computer system can then selectively return the food formula to the research portal for a user to review responsive to the total taste score approximating a baseline taste score for the product.

In one implementation, the computer system can access the semantic network including the set of nodes representing food concepts and labeled with taste qualities and receive the baseline food formula from the research portal specifying the baseline set of ingredients and the baseline set of processes for a particular product. The computer system can then: identify a node, in the set of nodes, representing a baseline ingredient in the semantic network; detect a subset of nodes, in the set of nodes, representing a first set of food molecules contained in the ingredient in the semantic network; and calculate a taste score in a set of taste scores—such as a taste quality score representing a particular taste quality (e.g., sweet, salty, bitter, savory, and sour)—of the ingredient based on the baseline set of processes and a particular taste quality, in a set of taste qualities, associated with the set of food molecules. The computer system can repeat these methods and techniques for each other baseline ingredient and for each other taste score to generate a baseline taste score (e.g., a baseline taste vector including the set of taste scores) for the baseline food formula representing a predicted taste perception during consumption of the product by a human.

The computer system can then execute Blocks of the method S100 to identify a second set of nodes, in the semantic network, representing a secondary set of target ingredients nearest the target ingredient; to identify a set of connections, in the semantic network, representing a set of processes linking the target ingredient and the secondary set of target ingredients in the semantic network; and to aggregate the target ingredient, the secondary set of target ingredients, and the first set of processes into a first food formula.

Furthermore, the computer system can: detect a subset of nodes, in the second set of nodes, representing a second set of food molecules contained in a secondary target ingredient in the semantic network; calculate a taste score, in a second set of taste scores, of the secondary target ingredient based on the set of processes and taste qualities associated with the second set of food molecules; generate a total taste score of the first food formula, in the set of food formulas, for the product based on the set of taste scores; and, in response to the total taste score approximating the baseline taste score, serve the first food formula for the product to a user within the research portal.

Therefore, the computer system can calculate taste scores of a set of taste qualities of the baseline set of ingredients specified in the baseline food formula for a particular product to generate a baseline taste score. Additionally, the computer system can: identify a set of ingredients and processes in the semantic network; aggregate these ingredients and processes into a new food formula for the particular product; and calculate taste scores of the set of taste qualities of this set of ingredients in order to generate a total taste score for the new food formula representing a predicted taste perception during consumption of a particular product by a human. The computer system can then selectively present the new food formula for the particular product within the research portal according to the total taste score rather than the sensory profile.

### 8.3.1 Multi-Dimensional Vector Space

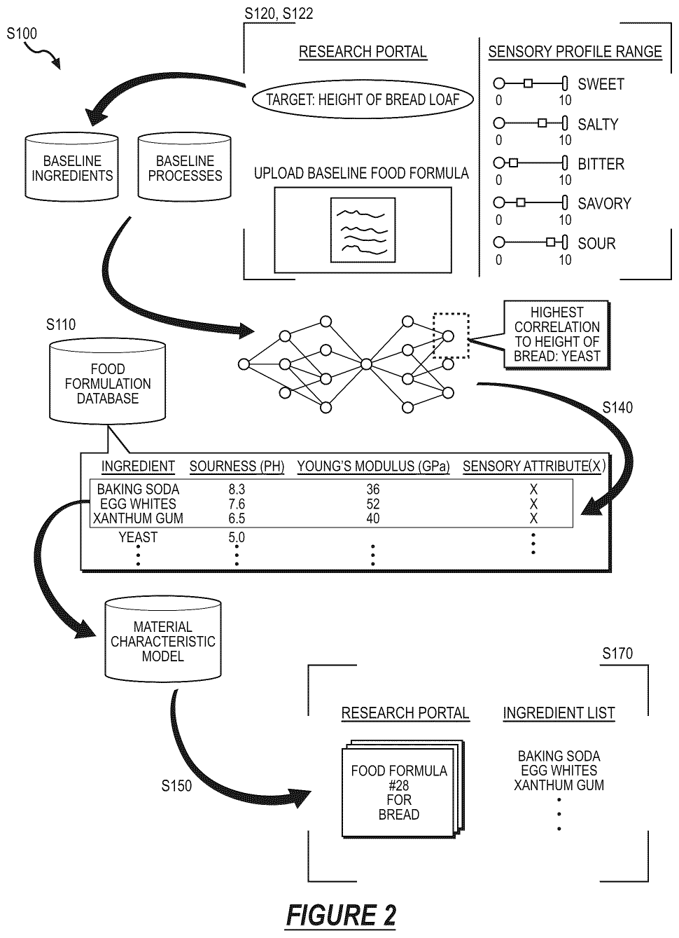

In one variation, the computer system can autonomously construct, maintain, and update vector representations of taste scores in a multi-dimensional space. In particular, the computer system can: transform the baseline set of taste scores into a baseline vector annotated with a corresponding product; transform the set of taste scores associated with the new food formula into a first vector annotated with the corresponding product; represent these vectors in a multi-dimensional space; and render the new food formula within the research portal based on proximity between the baseline vector and the first vector within the multi-dimensional space (e.g., a Euclidean distance between the baseline vector and the first vector), as shown in FIG. 2.

For example, the computer system can: represent the baseline set of taste scores as a baseline vector, representing a unique combination of taste qualities (e.g., sweet, salty, bitter, savory, and sour) for a protein bar, in the multi-dimensional space; represent the set of taste scores associated with the new food formula for the protein bar as a first vector in the multi-dimensional space; detect a Euclidean distance between the baseline vector and the first vector within the multi-dimensional space; and, in response to detecting the Euclidean distance between the baseline vector and the first vector, render the new food formula for the protein bar, predicted to yield the baseline taste score, within the research portal.

Furthermore, the computer system can repeat these methods and techniques for a corpus of products and represent a corpus of vectors within the multi-dimensional space. The computer system can then implement structured data analysis techniques (e.g., linear regression analysis, cluster analysis, k-means clustering, and/or other statistical analysis and machine learning techniques) to partition the corpus of vectors—each uniquely representing multiple taste qualities for a product—into multiple groups or “clusters” of vectors representing similar combinations of taste qualities in one or more dimensions in the multi-dimensional space.

### 8.4 Material Characteristic Prediction Modeling

In one implementation, the computer system can receive a query for a target material characteristic of a product and automatically derive a set of correlations between food molecules, contained in the baseline set of ingredients, and the target material characteristic (e.g., cost of material, height, appearance) of the product informed by the semantic network. The computer system can: rank each correlation in numerical order according to strength of association; generate a material characteristic model for the product by linking food molecules to the target ingredient according to the highest-ranking correlations; and implement the material characteristic model to generate a new food formula for the product to achieve the target material characteristic, as shown in FIG. 2.

In one variation the computer system can: receive a query for a target material characteristic of a product (e.g., a height of a loaf of bread, cost for a loaf of bread); derive a set of correlations between food molecules, contained in the baseline set of ingredients, and the target material characteristic of the product informed by the semantic network; and rank each correlation, in the set of correlations, in numerical order according to strength of association between the food molecule and the target material characteristic. The computer system can then: identify a food molecule associated with a highest-ranking correlation; detect a target node representing the food molecule in the semantic network; and identify a set of nodes representing ingredients nearest the food molecule represented in the target node. The computer system can: insert each ingredient into the material characteristic model to generate a food formula, in a set of food formulas, for the product to achieve the target material characteristic; and return the set of food formulas and/or the list of ingredients to the research portal for the user to review.

For example, the computer system can: receive a query specifying a target height for a loaf of bread; identify enzymes in yeast that ferment sugar and form carbon dioxide and ethanol during the rising process; derive a positive correlation between carbon dioxide and the target height for the loaf of bread; identify a food molecule associated with a highest-ranking correlation, such as yeast; detect a target node representing yeast in the semantic network; identify a set of nodes representing ingredients nearest yeast in the semantic network (e.g., xanthan gum, psyllium husk, hemicellulose, lemon juice, or baking soda); insert each ingredient into the material characteristic model to generate a food formula, in a set of food formulas, for the product to achieve the target height for the loaf of bread; and return the set of food formulas to the research portal for the user to review.

Therefore, the computer system can derive and implement a material characteristic model to identify and propose: food formulas specifying target ingredients or substitute ingredients for the product that address a target material characteristic of interest to the user.

### 9. Filter+Threshold Selection

In one implementation, the computer system can present lists of food concepts (e.g., ingredients, processes) and/or a set of food formulas that fulfill the user's search terms and yield a sensory profile analogous to the baseline sensory profile within the research portal for review by a user. The user may then select a filter and/or a threshold at the research portal to further refine the list of food concepts and/or the set of food formulas. The computer system can then: interface with the research portal to receive these selections; query the semantic network for concepts that match or approximate the search terms according to the filter; return a list of these matched concepts according to the selected filter; and/or revise a previously generated list of concepts or food formulas according to the filter, as shown in FIG. 4A.

In one example, the user selects a process threshold, such as five processes, for a loaf of bread at the research portal. The computer system: receives selection of the process threshold for the loaf of bread from the research portal; detects a quantity of the set of processes in the food formula; and, in response to the sensory profile approximating the baseline sensory profile and in response to the quantity of the set of processes (e.g., four processes) falling below the process threshold (e.g., five processes), returns the food formula, in the set of food formulas, for the loaf of bread to the research portal.

In another example, the user selects a target nutritional value range, such as a target protein value range, for the loaf of bread at the research portal. The computer system receives selection of the target protein value range for the loaf of bread from the research portal; identifies a set of nodes representing a second set of target ingredients; detects a subset of nodes, in the set of nodes, representing a set of macronutrients contained in a secondary target ingredient; and calculates a nutritional value (e.g., a value on a scale from 1 to 10, a percentage between 0 percent and 99 percent) of the secondary target ingredient based on the set of macronutrients. The computer system repeats these methods and techniques for each other secondary target ingredient to generate a set of nutritional values.

The computer system then: calculates a total nutritional value of the food formula for the loaf of bread representing an average value of the set of nutritional values; and, in response to the sensory profile approximating the baseline sensory profile and in response to the total nutritional value of the food formula falling within the target nutritional value range, returns the food formula, in the set of food formulas, for the loaf of bread to the research portal.

### 10. Virtual Product Node

Generally, the computer system can generate a virtual product node representing the product within the semantic network, identify a node representing the target ingredient in the semantic network, and exchange an analogous ingredient in the baseline food formula with the target ingredient to generate a food formula for the product.

In one implementation, the user may enter a query specifying a target substitute ingredient (e.g., a replacement ingredient) for a baseline ingredient in the baseline food formula that maintains the baseline sensory profile for the product to trigger the computer system to identify substitute ingredients predicted to yield the baseline sensory profile when combined (e.g., processed, mixed) with the remaining baseline set of ingredients. In this implementation, the computer system can: receive a baseline set of sensory attributes for the product at the research portal; project the baseline set of ingredients, the baseline set of processes, and the baseline set of sensory attributes onto the semantic network to generate the virtual product node representing the product; derive the baseline sensory profile based on a combination of the baseline set of sensory attributes for the product; and annotate the virtual product node with the baseline sensory profile.

The computer system can then: detect a target node representing the target ingredient in the semantic network; identify a set of connections, representing a set of processes, linking the target ingredient and the virtual product node in the semantic network; exchange a baseline ingredient, in the baseline set of ingredients, with the target ingredient to generate a food formula in a set of food formulas; revise the food formula with the set of processes; based on the sensory profile prediction model, the baseline set of sensory attributes for the product, sensory attributes associated with the target ingredient, and the first set of processes, predict a sensory profile of the food formula, in the set of food formulas, for the product; and, in response to the sensory profile approximating (e.g., corresponding to, analogous to, matching) the baseline food formula, return the food formula to the research portal.

### 10.1 Virtual Product Node: Modification of Quantities of Ingredients

In one variation, responsive to a difference (e.g., a mismatch, a discrepancy) between the sensory profile of the food formula and the baseline sensory profile of the baseline food formula, the computer system can modify a quantity (e.g., a concentration, a dry mass) of each ingredient in the baseline set of ingredients to reduce the difference between the sensory profile and the baseline sensory profile.

For example, the computer system can receive the baseline food formula for a loaf of bread specifying the baseline set of ingredients annotated with a baseline set of quantities, such as 240 milliliters of water, 60 milliliters of whole milk, 7 grams of instant yeast, 25 grams of granulated sugar, 56 grams of salted butter, 430 grams of all-purpose flour and specifying the baseline set of processes, such as “mix together water, milk, yeast, and sugar,” “add butter and flour,” etc. Responsive to detecting a difference between the sensory profile and the baseline sensory profile, the computer system can: adjust each quantity in the baseline set of quantities to generate a second food formula in the set of food formulas for the loaf of bread; and, based on the sensory profile prediction model, sensory attributes associated with the target ingredient and the secondary set of ingredients, and the first set of processes, predict a second sensory profile of the second food formula, in the set of food formulas, for the loaf of bread. Then, in response to the second sensory profile approximating (e.g., corresponding to, analogous to, matching) the baseline sensory profile, the computer system can return the second food formula to the research portal.

Therefore, the computer system can iteratively adjust a quantity of each baseline ingredient in order to reduce a difference between a sensory profile of a food formula and the baseline sensory profile of the baseline food formula for a particular product.

### 10.2 Virtual Product Node: Additive Ingredients

In one variation, responsive to a difference-such as a savory difference, a sweet difference, a salty difference-between the sensory profile of the food formula and the baseline sensory profile of the baseline food formula, the computer system can further detect a node, representing an additive ingredient for combination with the target ingredient, in the semantic network to reduce the difference between the sensory profile and the baseline sensory profile.

In the previous example, responsive to detecting a sweetness difference between the sensory profile and the baseline sensory profile, the computer system can: detect a node, in the semantic network, representing an additive ingredient (e.g., malt, honey) predicted to increase the sweetness of the loaf of bread; and revise the food formula with the additive ingredient (e.g., malt, honey) to generate a second food formula in the set of food formulas. The computer system can further calculate a second sensory profile of the second food formula, in the set of food formulas, for the loaf of bread based on: the sensory profile prediction model; sensory attributes associated with the target ingredient, the additive ingredient, and the baseline set of ingredients; and the first set of processes and the baseline set of processes. Then, in response to the second sensory profile approximating (e.g., corresponding to, analogous to, matching) the baseline sensory profile, the computer system can return the second food formula to the research portal.

Therefore, the computer system can identify additional additive ingredients in the semantic network to combine with the target ingredient in order to reduce a difference between a sensory profile of a food formula and the baseline sensory profile of the baseline food formula for a particular product.

### 11. Variation: Food Formulation Database

In one variation, the computer system can compile multitudes of data-such as sensory profile data, chemical compound data, food molecule data, ingredient data, product recipe data, gustatory sensation data, taste perception data, sensory perception data, aroma profile data, texture analysis data, food appearance data, and/or nutritional profile data-collected for populations of historical products produced, harvested, processed, and/or manufactured across multiple food types and multiple cuisines into a food formulation database. The computer system can execute Blocks of the method S100 to derive insights and additional information related to taste perception, health benefits, material properties, and/or manufacturing processes for a particular product from the food formulation database.

The computer system can serve these data, food formulas, instructions, insights, suggestions, and/or recommendations to users associated with a particular product, region of products, and/or product type—such as a consumer food manager, a farmer, a food supplier, a food scientist, a retailer, etc.—thus enabling these users to streamline research, development, processing, and manufacturing for products consumable by humans (and other animals).

Furthermore, the computer system can implement methods and techniques described above to extract food concepts within domains from the corpus of resources, to characterize their proximities in these documents and across the corpus of resources, and to represent these proximities within a food formulation database, such as a table, a catalog, a manifest, or a vector space model. In particular, the computer system can: extract a set of food concepts from the corpus of resources; store the set of food concepts extracted from the corpus of resources in a food formulation database; annotate each food concept with corresponding sensory attributes and material properties derived from the corpus of resources; and populate the food formulation database with a set of processes linking discrete food concepts in the set of food concepts.

The computer system can execute Blocks of the method S100 to generate a set of food formulas—defining ingredients, quantities of ingredients, and processes—for the product that are predicted to yield a sensory profile approximating the baseline sensory profile and/or a target sensory profile entered by the user and return these food formulas for the product to the research portal, as further described below.

### 11.1 Target Ingredient Identification+Food Formula Generation

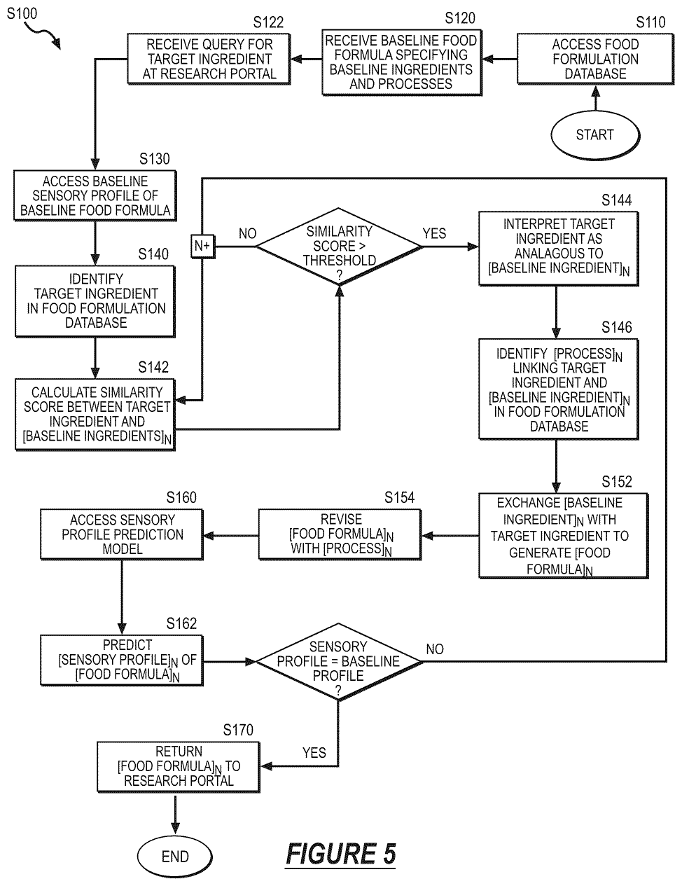

Generally, the computer system can execute Blocks of the method S100 to receive a baseline food formula defining a baseline set of ingredients and a baseline set of processes for a product; to receive a query specifying a target ingredient for the product; and to access a baseline sensory profile of the baseline food formula. The computer system can then generate a set of food formulas for the product informed by the food formulation database, as shown in FIG. 5.

In one implementation, the computer system can: identify the target ingredient analogous to an ingredient, in the baseline set of ingredients, in the food formulation database; identify a process, in the set of processes, linking the target ingredient and the ingredient in the food formulation database; exchange the ingredient, in the baseline set of ingredients, with the target ingredient within the baseline food formula to generate a food formula, in a set of food formulas, for the product; revise the food formula, in the set of food formulas, with the process; and, based on the sensory profile prediction model, sensory attributes associated with the target ingredient, and sensory attributes associated with the baseline set of ingredients, excluding the first ingredient, calculate a sensory profile of the food formula.

In one variation, the computer system can characterize a similarity score (e.g., a percentage between 0 percent and 99 percent, a value on a scale from one to ten, categorized as “poor,” “fair,” “good,” or “excellent”) between the target ingredient and each ingredient in the baseline set of ingredients based on analogous sensory attributes associated with the target ingredient and the baseline set of ingredients. The computer system can then interpret the target ingredient as analogous to a particular ingredient, in the baseline set of ingredients, responsive to a similarity score exceeding all other similarity scores (e.g., the highest similarity score).

Furthermore, responsive to the sensory profile approximating (e.g., analogous to, corresponding to, matching) the baseline sensory profile, the computer system can return the food formula, in the set of food formulas, for the product to the research portal.

### 12. Semantic Network Variation: Association Scores+Action Characteristics

In one variation, the computer system can: populate a semantic network with a constellation of nodes, each representing a unique food concept—in the set of target domains—described in at least one resource in the corpus of resources; label each node with its corresponding domain; define connections between nodes in the semantic network; label each connection with an association score for the two food concepts represented by the nodes its connects; and/or label each connection with an action characteristic derived from the word vector cube and/or interpreted directly from the corpus of resources into a semantic network.

### 12.1 Association Score

In one implementation, the computer system interprets strengths of associations (or “association scores”) between two food concepts based on proximity of these food concepts within the word vector cube—that is, inversely proportional to an n-dimensional distance between these two food concepts in the word vector cube.

In another implementation, for two food concepts (e.g., two words or two phrases) represented in the word vector cube, the computer system can calculate an association score: proportional to a number of times (or “frequency”) that two food concepts appear within the same resource (e.g., within the title, abstract, body, and/or footnotes of the resource); inversely proportional to a distance (e.g., a number of letters or words) between paired instances of these two food concepts in the resource; and/or proportional to a number of resources in the corpus of resources that includes at least one instance of these two food concepts.

Accordingly, the computer system can represent strengths of correlations between two food concepts based on proximity in the word vector cube and/or based on proximity of these two food concepts in individual resources across the corpus of resources.

Furthermore, the computer system can identify a food concept in the word vector cube as “ingredient” if a combination (e.g., sum) of the association scores between the food concept and known ingredient-related language descriptors (e.g., ingredient, fruit, grain, protein, spices, vegetable, natural flavor, and/or nutrient) exceeds a threshold score.

### 12.2 Action Characteristics

Furthermore, the computer system can derive an action characteristic representing positive or negative correlation between two food concepts (e.g., in the same or different domains) based on affirmative and negative language contained in the corpus of resources and/or represented in the word vector cube.

In one implementation, the computer system calculates action characteristics between −1.000 and +1.000. In particular, for two food concepts represented in the word vector cube, the computer system can calculate a negative action component: proportional to a number of times (or “frequency”) that the two food concepts appear within the same resource with negative language (e.g., “not,” “yuck”, “too”, “gross,” “bland,” “stale,” “bad”) surrounding or arranged between these two food concepts; inversely proportional to the distance (e.g., number of letters or words) between these two food concepts and negative language in the resource; and proportional to a number of resources that includes both food concepts with interstitial negative language. The computer system can similarly calculate a positive action component for the two food concepts: proportional to a number of times that two food concepts appear within the same resource without negative language or with positive language (e.g., “yummy,” “mouth-watering”, “great”, “flavorful,” “delicious,” “amazing,” “good”) between the two food concepts; inversely proportional to the distance (e.g., number of letters or words) between these two food concepts with no negative language and/or with positive language therebetween in the resource; and proportional to a number of resources that includes both food concepts with no interstitial negative language and/or with no interstitial positive language. The computer system can then combine (e.g., sum, average) the negative and positive action component to derive a (composite) action characteristic between the two food concepts.

### 12.3 Semantic Network Construction

The computer system can therefore: fuse the corpus of resources into a network of language embeds (e.g., a “word vector cube”); derive association scores between food concepts represented in the word vector cube; detect or predict domains of food concepts in the word vector cube; derive action characteristics between food concepts represented in the word vector cube; represent these food concepts as nodes in the semantic network; label each node with the domain of the food concept it represents; connect (or “link”) pairs of nodes according to the association scores for pairs of food concepts represented by these nodes; and label connections between nodes with action characteristics and association scores for pairs of food concepts represented by these nodes.

### 12.4 Food Formula Filter

In one implementation, the computer system can interface with a user to access a food formula (e.g., production process, product design) associated with a particular product. The computer system can then implement machine learning and computer vision techniques (e.g., filtering algorithms, restriction algorithms, data reduction) to query the semantic network for a target population of nodes labeled with food concepts contained in the food formula and/or associated with the particular product. The computer system can further mute nodes of the semantic network labeled with food concepts excluded from the food formula and/or associated with the particular product.

In one variation, the user can input a baseline food formula including a set of manufacturing processes, a set of ingredients, and a sensory profile associated with a particular product within the research portal. The computer system can then receive this baseline food formula within the research portal and extract a set of food concepts from the set of manufacturing processes, the set of ingredients, and the sensory profile associated with the particular product. The computer system can store the set of food concepts in a container labeled with the baseline food formula. The computer system can then leverage the container as a filter for the semantic network to generate a list of ingredients, a new product, and/or a list of manufacturing processes available to the user for the particular product.

For example, the computer system can receive a baseline food formula for a protein bar within the research portal including: a set of baseline ingredients (e.g., oats, protein powder, peanut butter, sugar, banana, salt, vanilla extract); a set of baseline manufacturing processes (e.g., mixing set of ingredients, extrusion of mixture to form bars, heating bars, cooling bars, packaging bars); a baseline sensory profile (e.g., a sweet taste quality, a salty taste quality, a chewy taste quality, a soft taste quality); and a baseline nutritional profile (e.g., calories, protein, fats, carbohydrates, sugars, sodium) associated with the protein bar. The computer system can then: extract food concepts from the set of baseline ingredients, the set of baseline manufacturing processes, the baseline sensory profile, and the baseline nutritional profile; store these food concepts in a container; and based on food concepts stored in the container, identify a region of the semantic network including a set of nodes representing food concepts corresponding to the set of food concepts from the baseline food formula.

The computer system can further implement machine learning and computer vision techniques to mute nodes labeled with food concepts excluded from the set of food concepts from the baseline food formula within the semantic network; generate a visualization of the region of the semantic network representing the set of nodes labeled with food concepts corresponding to the set of food concepts; and render this visualization of the region of the semantic network for presentation within the research portal.

Therefore, the computer system can access food concepts from a food formula defined by the user in order to filter the semantic network for a particular region of nodes representing food concepts associated with the food formula and present this particular region to a user for selection of a target food concept and/or a target domain.

### 12.5 User Query: Target Food Concept+Target Domain

Generally, the computer system can prompt the user to enter a set of natural language search terms representing a target food concept and/or a target domain within the research portal.

Furthermore, the computer system interfaces with the research portal to receive a set of natural language search terms entered by the user to select a target food concept and/or a target domain. The set of natural language search terms can include one or more of: a particular sensory profile or a generic sensory profile domain term; a particular ingredient or a generic ingredient domain term; a particular nutrient or a generic nutritional profile domain term; a particular manufacturing process or a generic manufacturing process domain term; a particular mouthfeel characteristic or a generic texture domain term; a particular volatile organic compound, aroma molecule, and/or odorant or generic aroma profile domain term; a particular dimension, shape, and/or color or a generic appearance domain term; a particular product or a generic product domain term; and a particular chemical compound or a generic chemical compound domain term.

In one example, the user may hypothesize that replacing an ingredient, such as cane sugar, with a natural sweetener, such as maple syrup, may be effective in increasing the nutritional profile of a protein bar and thus increase the health benefits of the protein bar. However, the maple syrup may alter the taste qualities of the protein bar and cause the protein bar to exhibit a new sensory profile during consumption. Thus, the user can input the baseline sensory profile, the baseline nutritional profile, and the baseline list of ingredients available to the user for the protein bar within the research portal, select the baseline sensory profile as the target sensory profile, and select a target ingredient domain. The computer system can then execute Blocks of the method S100 to generate a list of substitute ingredients for cane sugar that can increase the nutritional profile of the protein bar and return this list of substitute ingredients to the user.

Additionally or alternatively, the computer system can interface with the research portal to receive selection of a target ingredient from the list of replacement ingredients from the user. The computer system can then: identify a connection connecting a target node representing the target sensory profile and a termination node representing the target ingredient; extract a set of manufacturing processes from intermediate nodes along the connection; generate a list of manufacturing processes for the target ingredient; and return this list of manufacturing processes within the research portal, as further described below.

In another example, the user may wish to generate a new product (e.g., a chocolate bar) with the baseline list of ingredients available to the user. However, the new product (e.g., a chocolate bar) may exhibit a new sensory profile during consumption. Thus, the user can input the baseline sensory profile, the baseline nutritional profile, the baseline list of ingredients available to the user for the baseline product (e.g., a protein bar) within the research portal, select the baseline sensory profile as the target sensory profile and select a target product domain. The computer system can similarly execute Blocks of the method S100 to generate a list of new products—each product containing the baseline list of ingredients—exhibiting the baseline sensory profile and return this list of new products to the user.

Therefore, the computer system can generate a list of ingredients, a new product, and/or a list of manufacturing processes and thereby enable a user to selectively target research and development of certain products and/or to improve an existing product based on the list of ingredients, the new product, and/or the list of manufacturing processes.

### 12.5.1 Sensory Profile as Input

Generally, the computer system can interface with the user portal to receive a query for a set of natural language search terms entered by a user, such as a baseline food formula specifying a baseline set of ingredients and a baseline set of processes for a particular product manufactured by a user.

In one implementation, the computer system prompts the user to enter or define a target sensory profile. The computer system then interfaces with the user and searches the semantic network to: identify and select a target ingredient that may affect the target sensory profile; identify a target action pathway-corresponding to a target taste quality predicted by consumption of the target ingredient-defined by a series of nodes connecting the target sensory profile and the target ingredient in the semantic network; and extract a set of manufacturing processes that uniquely distinguish the target action pathway from other action pathways connecting the target sensory profile and the target ingredient in the semantic network.

### 12.6 Proximal Ingredients

In one implementation, the computer system can then query the semantic network for a set of nodes representing ingredient food concepts (e.g., chocolate chips, protein powder, peanut butter) proximal the target node representing the target ingredient (e.g., oats) in the semantic network. In particular, once the user enters the baseline food formula and a query for the target ingredient, the computer system can scan the semantic network for an address of a target node within the “ingredient” domain and containing a language food concept representing the target ingredient.

In one variation, the computer system can scan the semantic network for a set of nodes—within the ingredient domain—nearest the target node. For example, the computer system: identifies a target node representing the target ingredient; defines a threshold distance (e.g., a threshold Euclidean distance in n-dimensions of the semantic network) proportional to a target quantity of ingredients, such as five ingredients, nearest the target ingredient; and identifies a set of nodes, representing a secondary set of target ingredients, within the threshold distance of the target node.

In another example, the computer system identifies a set of nodes, representing secondary target ingredients, within a threshold distance of the target node, such as a threshold Euclidean distance in n-dimensions of the semantic network between each node in the set of nodes and the target ingredient node.

In yet another example, the computer system identifies a target quantity of ingredients, such as 10 ingredients, nearest the target node (e.g., in a Euclidean distance in n-dimensions of the semantic network) or connected to the target node by fewest intermediate nodes.

### 12.7 New Food Formula: Multi-Step Pathway

In on implementation, the user can select a target ingredient from the list of replacement ingredients within the research portal and the computer system can implement methods and techniques described above to return a list of manufacturing processes associated with the target ingredient to the user. Further, the computer system can: query the semantic network for a set of nodes representing food concepts that match or approximate the target ingredient; and return a list of manufacturing processes for the product that fulfill the user's target food concept, that are directly connected (e.g., found in the corpus of resources) or indirectly connected (e.g., found in food blogs, rather than peer reviewed scientific publications) in the semantic network, and that are predicted to exhibit correlation within the set of nodes.

In one variation, the user selects a target ingredient from the list of replacement ingredients within the research portal and the computer system can: identify a connection coupling a target node representing the target sensory profile and a termination node representing the target ingredient, separated by fewer than a threshold quantity of intermediate nodes (e.g., one, three, four), in the semantic network; extract a set of manufacturing processes from intermediate nodes, storing food concepts, along the connection; generate a list of manufacturing processes for the target ingredient; and return this list of manufacturing processes for the target ingredient to the user within the research portal.

Additionally or alternatively, the user selects a target ingredient from the list of replacement ingredients within the research portal and a target manufacturing process range analogous to the set of baseline manufacturing processes for the baseline food formula. The computer system can then: identify a connection coupling the target node representing the target sensory profile and the termination node representing the target ingredient, separated by fewer than a threshold quantity of intermediate nodes, in the semantic network; extract a set of manufacturing processes from intermediate nodes, storing food concepts, along the connection; select a first manufacturing process, in the set of manufacturing processes, from an intermediate node; and in response to the first manufacturing process in the set of manufacturing processes falling outside of the target manufacturing process range, select a second manufacturing process in the set of manufacturing processes. Then, in response to the second manufacturing process in the set of manufacturing processes falling within the target manufacturing process range, the computer system can aggregate the target ingredient, the first manufacturing process, and the baseline food formula associated with the particular product into a new (e.g., updated) food formula for the product such that the product exhibits the baseline sensory profile and the baseline nutritional profile.

Therefore, the computer system can implement methods and techniques described above to generate a list of replacement ingredients, receive selection of a target ingredient and a target manufacturing process range, generate a new food formula defining the replacement ingredient and a corresponding manufacturing process for the particular product, and thereby enable a user to streamline research and development of the particular product.

### 12.8 Corpus of Food Formulas

In one variation, the user can input a corpus of food formulas for all products associated with a production company within the research portal. Each food formula can include a set of manufacturing processes, a set of ingredients, and a sensory profile associated with a particular product within the research portal. The computer system can then receive each food formula within the research portal and extract a set of food concepts from the set of manufacturing processes, the set of ingredients, and the sensory profile associated with the particular product. The computer system can store the set of food concepts in a container, in a set of containers, labeled with the corresponding food formula. The computer system can then leverage the set of containers as a filter for the semantic network to generate a list of ingredients, a new product, and/or a list of manufacturing processes available to the user for a particular product.

For example, a food scientist affiliated with a production company can input a corpus of food formulas for all products—such as including rice, candy, chocolate bars, gum, sauces, marinades, veggie bowls, protein bowls, pasta, burritos, crackers, chips, burgers, sandwiches, etc.—generated by the production company within the research portal. The computer system can then: extract a set of food concepts unique to the set of manufacturing processes, the set of ingredients, and the sensory profile of each food formula; store each set of food concepts in a container, in a set of containers, labeled with a corresponding food formula; implement machine learning and artificial intelligence techniques (e.g., filtering algorithms, restriction algorithms, data reduction) to query the semantic network for a target population of nodes labeled with food concepts contained in the corpus of food formulas based on the set of containers; and identify regions of the semantic network including the target population of nodes representing food concepts corresponding to food concepts from the corpus of food formulas.

The user may input a target ingredient and a target product domain within the research portal. The computer system can: identify a set of connections between a target node representing the target ingredient and a subset of nodes labeled with a product within the semantic network; generate a list of products containing the target ingredient based on association scores stored along the set of connections; and render the list of products within the research portal. The user can then select a target product from the list of products within the research portal. The computer system can: identify a connection coupling a target node representing the target ingredient and a termination node representing the target product, separated by fewer than a threshold quantity of intermediate nodes (e.g., one, three, four), in the semantic network; extract a set of manufacturing processes from intermediate nodes, storing food concepts, along the connection; generate a list of manufacturing processes for the target product; aggregate ingredients, the list of manufacturing processes, and the target product into a new food formula for the target product; and return this new food formula for the target product to the user within the research portal.

Therefore, the computer system can selectively filter the semantic network for food concepts corresponding to a corpus of food formulas representing all products of a production company. The computer system can then derive a possible food formula with ingredients and manufacturing processes currently available to a food scientist, associated with the product company, from the semantic network and thus enable the food scientist to prioritize research and development of the possible food formula.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a semantic network comprising:
a first set of nodes representing food concepts and labeled with sensory attributes; and
connections between nodes representing processes linking discrete food concepts represented in the first set of nodes;
at a research portal:
receiving a baseline food formula specifying a baseline set of ingredients and a baseline set of processes for a product; and
receiving a query for a target ingredient;
based on the semantic network, deriving a baseline sensory profile of the baseline food formula for the product;
generating a set of food formulas predicted to yield the baseline sensory profile by:
identifying a second set of nodes, in the semantic network, representing a secondary set of target ingredients nearest the target ingredient;
identifying a first set of connections, in the semantic network, representing a first set of processes linking the target ingredient and the secondary set of target ingredients;
aggregating the target ingredient, the secondary set of target ingredients, and the first set of processes into a first food formula, in the set of food formulas;
accessing a sensory profile prediction model representing relationships between sensory attributes of the baseline set of ingredients and the baseline set of processes for the product; and
based on the sensory profile prediction model, the first set of processes, and sensory attributes of the target ingredient and the secondary set of target ingredients, predicting a first sensory profile of the first food formula, in the set of food formulas, for the product; and
in response to the first sensory profile approximating the baseline sensory profile, returning the first food formula, in the set of food formulas, for the product to the research portal.

2. The method of claim 1, further comprising:
in response to detecting a difference between the first sensory profile and the baseline sensory profile:
identifying a third set of nodes, in the semantic network, representing a tertiary set of additive ingredients predicted to reduce the difference between the first sensory profile and the baseline sensory profile;
identifying a third set of connections, in the semantic network, representing a third set of processes linking the secondary set of target ingredients and the tertiary set of additive ingredients;
aggregating the target ingredient, the secondary set of target ingredients, the first set of processes, the tertiary set of additive ingredients, and the third set of processes into a second food formula, in the set of food formulas; and
predicting a second sensory profile of the second food formula in the set of food formulas based on:
the sensory profile prediction model;
sensory attributes associated with the target ingredient, the secondary set of ingredients, and the tertiary set of additive ingredients; and
the first set of processes and the third set of processes; and
in response to the second sensory profile approximating the baseline sensory profile, returning the second food formula, in the set of food formulas, for the product to the research portal.

3. The method of claim 1:
wherein aggregating the target ingredient, the secondary set of target ingredients, and the first set of processes into the first food formula comprises:
generating a first set of quantities of the secondary set of target ingredients predicted to yield the baseline sensory profile when combined with the target ingredient; and
compiling the target ingredient, the secondary set of target ingredients annotated with the first set of quantities, and the first set of processes into the first food formula, in the set of food formulas; and
wherein predicting the first sensory profile of the first food formula comprises:
based on the sensory profile prediction model, the first set of quantities, the first set of processes, and sensory attributes associated with the target ingredient and the secondary set of ingredients, calculating the first sensory profile, in the first food formula, in the set of food formulas, for the product.

4. The method of claim 3, further comprising:
in response to detecting a difference between the first sensory profile and the baseline sensory profile:
modifying the first set of quantities of the secondary set of target ingredients to generate a second set of quantities different from the first set of quantities; and
compiling the target ingredient, the secondary set of target ingredients annotated with the second set of quantities, and the first set of processes into a second food formula, in the set of food formulas;
based on the sensory profile prediction model, the second set of quantities, the first set of processes, and sensory attributes associated with the target ingredient and the secondary set of ingredients, calculating a second sensory profile of the second food formula, in the set of food formulas, for the product; and
in response to the second sensory profile approximating the baseline sensory profile, rendering the second food formula, in the set of food formulas, for the product within the research portal for a user to review.

5. The method of claim 1:
wherein accessing the semantic network comprises accessing the semantic network comprising the first set of nodes representing food concepts and labeled with taste qualities; and
wherein deriving the baseline sensory profile for the baseline food formula of the product comprises:
for each ingredient in the baseline set of ingredients:
identifying a node, in the first set of nodes, representing the ingredient in the semantic network;
detecting a first subset of nodes, in the first set of nodes, representing a first set of food molecules contained in the ingredient in the semantic network; and
calculating a taste score, in a set of taste scores, of the ingredient based on the baseline set of processes and taste qualities associated with the set of food molecules; and
generating a baseline taste score for the baseline food formula based on the set of taste quality scores.

6. The method of claim 1:
further comprising, for each product in a set of products:
accessing a corpus of scientific publications;
extracting a baseline food formula in a set of baseline food formulas, specifying a baseline set of ingredients and a baseline set of processes for the product, from the corpus of scientific publications;
extracting a baseline sensory profile, representing a set of sensory attributes, for the product from the corpus of scientific publications; and
representing the baseline food formula and baseline sensory profile in a first container, in a set of containers, associated with the food product; and
wherein accessing the sensory profile prediction model comprises, based on the set of containers, deriving the sensory profile prediction model linking baseline sets of ingredients and baseline sets of processes to baseline sensory profiles.

7. The method of claim 1:
wherein accessing the semantic network comprises accessing the semantic network comprising the first set of nodes representing food concepts and labeled with taste qualities;
wherein deriving the baseline sensory profile for the baseline food formula comprises receiving a baseline taste score of the baseline food formula for the product from the research portal;
wherein predicting the first sensory profile of the first food formula comprises:
for each ingredient in the secondary set of ingredients:
detecting a second subset of nodes, in the second set of nodes, representing a second set of food molecules contained in the ingredient in the semantic network; and
calculating a taste score, in a set of taste scores, of the ingredient based on the first set of processes and taste qualities associated with the second set of food molecules; and
generating a total taste score of the first food formula, in the set of food formulas, for the product based on the set of taste scores; and
further comprising, in response to the total taste score approximating the baseline taste score, serving the first food formula, in the set of food formulas for the product, to a user.

8. The method of claim 7, further comprising:
representing the baseline taste score as a baseline vector in a multi-dimensional space containing vectors representing total taste scores of the set of food formulas;
representing the total taste score of the first food formula as a first vector in the multi-dimensional space; and
rendering the first food formula, in the set of food formulas, for the product within the research portal for the user to review based on proximity between the baseline vector and the first vector.

9. The method of claim 1:
further comprising:
receiving selection of a target nutritional value range for the product at the research portal;
for each ingredient in the secondary set of ingredients:
detecting a first subset of nodes, in the first set of nodes, representing a first set of macronutrients contained in the ingredient in the semantic network; and
calculating a nutritional value, in a set of nutritional values, of the ingredient based on the first set of macronutrients contained in the ingredient; and
calculating a total nutritional value of the first food formula, in the set of food formulas, for the product based on the set of nutritional values; and
wherein returning the first food formula, in the set of food formulas, for the product to the research portal comprises returning the first food formula, in the set of food formulas, for the product to the research portal:
in response to the first sensory profile approximating the baseline sensory profile; and
in response to the total nutritional value of the first food formula falling within the target nutritional value range.

10. The method of claim 1:
further comprising:
receiving selection of a process threshold for the product at the research portal; and
detecting a quantity of the first set of processes in the first food formula; and
wherein returning the first food formula, in the set of food formulas for the product, to the research portal comprises returning the first food formula, in the set of food formulas for the product, to the research portal:
in response to the first sensory profile approximating the baseline sensory profile; and
in response to the quantity of the first set of processes falling below the process threshold.

11. The method of claim 1:
further comprising:
receiving a baseline set of sensory attributes for the product at the research portal; and
projecting the baseline set of ingredients, the baseline set of processes, and the baseline set of sensory attributes onto the semantic network to generate a virtual product node representing the product;
wherein deriving the baseline sensory profile of the baseline food formula comprises:
deriving the baseline sensory profile based on a combination of the baseline set of sensory attributes for the product; and
annotating the virtual product node with the baseline sensory profile;
wherein identifying the second set of nodes, in the semantic network, representing the secondary set of ingredients comprises detecting a first node, in the first set of nodes, representing the target ingredient in the semantic network;
wherein identifying the first set of connections comprises identifying the first set of connections, representing the first set of processes, linking the target ingredient and the virtual product node in the semantic network;
wherein aggregating the target ingredient, the secondary set of target ingredients, and the first set of processes into the first food formula comprises:
exchanging a first ingredient, in the baseline set of ingredients, with the target ingredient to generate the first food formula in the set of food formulas; and
revising the first food formula with the first set of processes; and
wherein predicting the first sensory profile of the first food formula comprises:
based on the sensory profile prediction model, the baseline set of sensory attributes for the product, sensory attributes associated with the target ingredient, and the first set of processes, predicting the first sensory profile of the first food formula, in the set of food formulas, for the product.

12. The method of claim 11:
wherein receiving the baseline food formula comprises, at the research portal, receiving the baseline food formula for the product specifying the baseline set of ingredients annotated with a baseline set of quantities;
further comprising, in response to detecting a difference between the first sensory profile and the baseline sensory profile:
adjusting each quantity in the baseline set of quantities to generate a second food formula in the set of food formulas; and
based on the sensory profile prediction model, sensory attributes associated with the target ingredient and the secondary set of ingredients, and the first set of processes, predicting a second sensory profile of the second food formula, in the set of food formulas, for the product; and
further comprising, in response to the second sensory profile approximating the baseline sensory profile, returning the second food formula, in the set of food formulas, to the research portal.

13. The method of claim 11, further comprising:
in response to detecting a difference between the first sensory profile and the baseline sensory profile:
detecting a second node, in the first set of nodes, representing an additive ingredient predicted to reduce the difference between the first sensory profile and the baseline sensory profile;
revising the first food formula with the additive ingredient to generate a second food formula in the set of food formulas; and
predicting a second sensory profile of the second food formula, in the set of food formulas, for the product based on:
the sensory profile prediction model;
sensory attributes associated with the target ingredient, the additive ingredient, and the baseline set of ingredients; and
the first set of processes and the baseline set of processes; and
in response to the second sensory profile approximating the baseline sensory profile, returning the second food formula, in the set of food formulas, to the research portal.

14. The method of claim 1, wherein identifying the second set of nodes, in the semantic network, representing the secondary set of target ingredients comprises:
identifying a target node representing the target ingredient;
defining a threshold distance proportional to a target quantity of ingredients nearest the target ingredient; and
identifying the second set of nodes, representing the secondary set of target ingredients, within the threshold distance of the target node.

15. The method of claim 1:
further comprising accessing a food formulation database comprising:
a first set of food concepts labeled with sensory attributes; and
a first set of processes linking discrete food concepts in the first set of food concepts;
wherein deriving the baseline sensory profile of the baseline food formula comprises deriving the baseline sensory profile of the baseline food formula for the product based on the food formulation database;
wherein identifying the second set of nodes, in the semantic network representing the secondary set of target ingredients comprises identifying a first set of target ingredients, comprising the target ingredient, in the food formulation database;
wherein identifying the first set of connections, in the semantic network, representing the first set of processes comprises identifying the first set of processes linking the target ingredient and discrete ingredients in the first set of target ingredients in the food formulation database; and
wherein aggregating the target ingredient, the secondary set of target ingredients, and the first set of processes into the first food formula comprises aggregating the first set of target ingredients and the first set of processes into the first food formula.

16. A method comprising:
accessing a food formulation database comprising:
a first set of food concepts labeled with sensory attributes; and
a first set of processes linking discrete food concepts in the first set of food concepts;
at a research portal:
receiving a baseline food formula defining a baseline set of ingredients and a baseline set of processes for a product; and
receiving a query specifying a target ingredient for the product;
accessing a baseline sensory profile of the baseline food formula for the product;
identifying the target ingredient analogous to a first ingredient, in the baseline set of ingredients, in the food formulation database;
identifying a first process, in the first set of processes, linking the target ingredient and the first ingredient in the food formulation database;
exchanging the first ingredient, in the baseline set of ingredients, with the target ingredient within the baseline food formula to generate a first food formula, in a set of food formulas, for the product;
revising the first food formula, in the set of food formulas, with the first process;
accessing a sensory profile prediction model representing relationships between sensory attributes of the baseline set of ingredients and the baseline set of processes for the product;
calculating a first sensory profile of the first food formula, in the set of food formulas, for the product based on:
the sensory profile prediction model;
sensory attributes associated with the target ingredient; and
sensory attributes associated with the baseline set of ingredients, excluding the first ingredient; and
in response to the first sensory profile approximating the baseline sensory profile, returning the first food formula, in the set of food formulas, for the product to the research portal.

17. The method of claim 16, wherein identifying the target ingredient analogous to the first ingredient in the baseline set of ingredients comprises:
identifying the target ingredient in the food formulation database;
calculating a similarity score between the target ingredient and the first ingredient in the baseline set of ingredients based on sensory attributes associated with the target ingredient and sensory attributes associated with the first ingredient; and
in response to the similarity score exceeding a threshold similarity score, interpreting the target ingredient as analogous to the first ingredient.

18. The method of claim 16, further comprising:
in response to detecting a difference between the first sensory profile and the baseline sensory profile:
identifying an additive ingredient predicted to reduce the difference between the first sensory profile and the baseline sensory profile in the food formulation database; and
exchanging the first ingredient with the target ingredient and the additive ingredient within the baseline formula to generate a second food formula, in the set of food formulas, for the product;
calculating a second sensory profile of the second food formula, in the set of food formulas, for the product based on:
the sensory profile prediction model;
sensory attributes associated with the target ingredient and the additive ingredient; and
sensory attributes associated with the baseline set of ingredients excluding the first ingredient; and
in response to the second sensory profile approximating the baseline sensory profile, returning the second food formula, in the set of food formulas, for the product to the research portal.

19. The method of claim 16:
further comprising accessing a semantic network comprising:
a first set of nodes representing the first set of food concepts and labeled with sensory attributes; and
a first set of connections between nodes representing the first set of processes linking discrete food concepts in the first set of food concepts;
wherein accessing the baseline sensory profile comprises deriving the baseline sensory profile of the baseline food formula for the product based on the semantic network;
wherein identifying the target ingredient analogous to the first ingredient comprises identifying a first node representing the target ingredient nearest the first ingredient, in the baseline set of ingredients, in the semantic network; and
wherein identifying the first process, in the first set of processes, linking the target ingredient and the first ingredient comprises identifying a first connection linking the target ingredient and the first ingredient in the semantic network.

20. A method comprising:
receiving a baseline food formula defining a baseline set of ingredients for a product;
receiving a query specifying a target ingredient for the product;
characterizing a baseline sensory profile of the baseline food formula for the product;
identifying the target ingredient analogous to a first ingredient, in the baseline set of ingredients, stored in a food formulation database;
identifying a first process, in a first set of processes, linking the target ingredient and the first ingredient in the food formulation database;
exchanging the first ingredient with the target ingredient within the baseline food formula to generate a first food formula, in a set of food formulas, for the product;
revising the first food formula, in the set of food formulas, with the first process;
predicting a first sensory profile of the first food formula, in the set of food formulas, for the product:
based on sensory attributes, stored in the food formulation database, associated with the target ingredient; and
based on sensory attributes, stored in the food formulation database, associated with the baseline set of ingredients excluding the first ingredient; and
in response to the first sensory profile approximating the baseline sensory profile, serving the first food formula, in the set of food formulas, for the product to a user.
